(19) United States
(12) Patent Application Publication
(10) Pub. No.: US 2025/0284142 A1
(43) Pub. Date: Sep. 11, 2025

(54) Dynamic extraocular filtering for correction of color contrast perception

(71) Applicant: Vladimir Mamchik, Hillsboro, OR (US)

(72) Inventor: Vladimir Mamchik, Hillsboro, OR (US)

(21) Appl. No.: 18/596,596

(22) Filed: Mar. 5, 2024

(51) Int. Cl. G02C 7/10; G02B 5/20; G02F 1/13

(52) U.S. Cl. CPC G02C 7/104; G02B 5/20; G02F 1/13

(57) ABSTRACT

Dynamic extraocular filtering is a correction method to improve color contrast recognition in color vision deficient observers (non-normal color vision). This method is based on actively controlling wavelength spectrum transmission to retinal photoreceptors, introducing a temporal contrast that is interpreted as color contrast by the observer. The method functions by utilizing an active filter that produces several filter conditions which change at a high frequency. This method changes filter conditions dynamically as opposed to current systems which rely on static band-stop filters.

### FIELD

This invention is in the field of vision correction and optometry.

### BACKGROUND

Current methods to correct color contrast perception in individuals with color vision deficiency can restrict more colors from being seen and not correct color vision as needed. There is an unmet need for a method that can provide correction to color contrast perception in color vision deficient individuals that improves color contrast perception while maintaining integrity of normal vision.

### OBJECTS OF THE INVENTION

It is the object of the invention to provide increased color contrast perception to observers with color vision deficiency by extraocular means.

### SUMMARY

Dynamic extraocular filtering as a method to correct color contrast perception involves a new approach to improve the ability to differentiate between chromatic hues in observers with color vision deficiency (or “colorblindness”).

This method involves dynamically changing the wavelength composition of perceived light through an active filter. The changing of filter conditions occurs at a high enough frequency that there is no perceivable chromatic difference in the filter conditions (seen as if a white filter) but the improvement to contrast perception remains.

In each filter condition, by selectively removing wavelengths of incoming spectra, a brightness difference is introduced between previously indistinguishable colors. Additionally, a full spectrum filter condition is used to include the full wavelength spectrum.

With these filter conditions being changed at high frequencies, the improved contrast is seen for all previously confusing colors along with the full spectrum of wavelengths, meaning no colors are restricted from being seen.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: An image depicting how dynamic extraocular filtering is used with human observers, held in front of the field of view as a visual assistive device. The observer looks through the active filter to perceive their surroundings.

FIG. 2: The basic construction of an active filter, including a front and back glass sheet as well as an inner liquid crystal layer to change wavelength transmissibility of filter.

FIG. 3: An illustration of the full spectrum filtering condition, showing no change in the wavelengths that go through the active filter.

FIG. 4: The magenta and cyan filter conditions (e.g. red and green-wavelength filtering), showing how the wavelengths that are perceived through the filter are different depending on the filter condition

FIG. 5: An illustration of the use of dynamic extraocular filtering, showing both the magenta and cyan filter conditions. When an apple of colors green and red are perceived through the active filter, colors of wavelengths filtered out are perceived with increased brightness contrast.

FIG. 6: Depiction of the same apple of colors green and red perceived with a full spectrum filter condition, showing no change in color contrast (i.e., full spectrum is being seen).

### DETAILED DESCRIPTION OF THE DRAWINGS

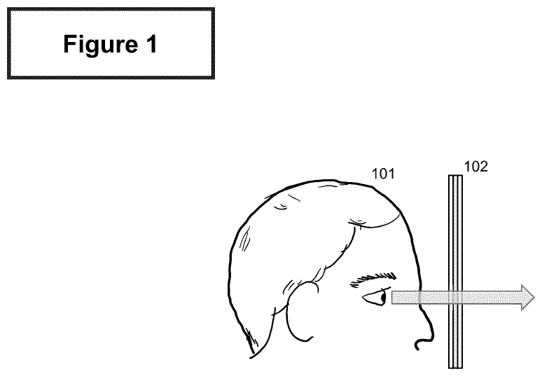

As seen in FIG. 1, the method of dynamic extraocular filtering is applied outside of the eyes, with the observer (101) using the active filter (102) in front of their field of view. This affects the perception of the observer, allowing the effect of dynamic extraocular filtering to improve color contrast perception.

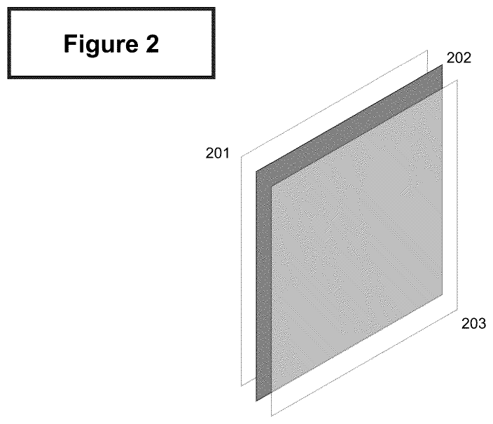

The construction of this active filter is further elaborated on in FIG. 2. The method of dynamic extraocular filtering works by using an active filter, or a filter which can quickly change wavelength transmissibility depending on a program. In FIG. 2, an example of an active filter is shown, composing of two layers of glass (201, 203) and a liquid crystal matrix in between (202).

This specific construction is simply one embodiment of an active filter which can be used in the application of dynamic extraocular filtering. The liquid crystal matrix can be programmed externally, changing the wavelength transmissibility through the filter depending on the color desired.

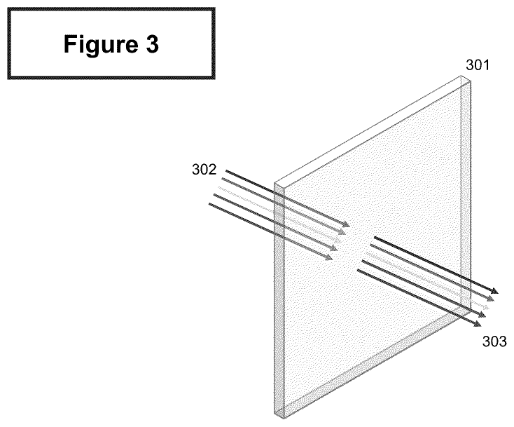

In FIG. 3, the full spectrum filter condition is shown, illustrating how the incoming light containing all wavelengths (302) goes through the active filter (301) and is outputted with no difference in wavelength composition (303). This condition is equivalent to a white filter, where no colors are being removed from the spectrum.

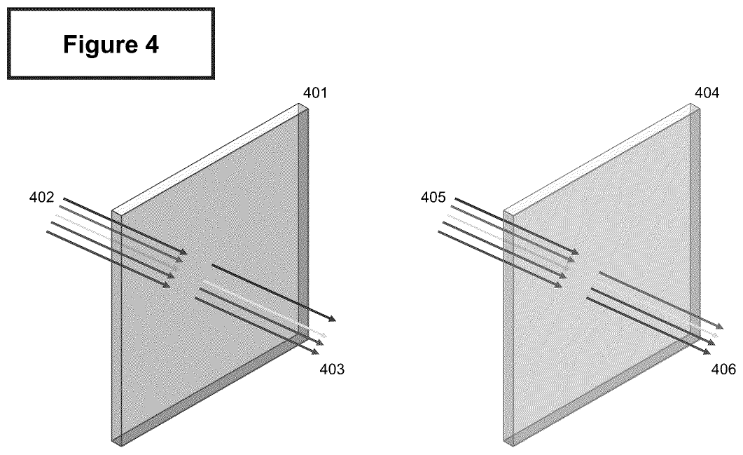

In FIG. 4, the magenta and cyan filter conditions are shown. The magenta filter (401) is set to selectively filter out green portions of the incoming spectrum (402), changing the wavelength composition of incoming light (403). Similarly, the cyan filter (404) is programmed to specifically remove red wavelengths from the incoming light (405), leading to a modified spectrum being perceived through the filter (406).

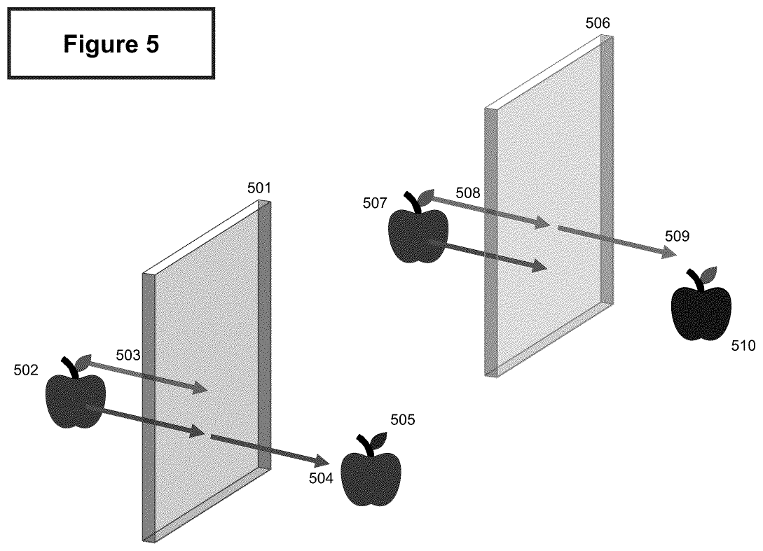

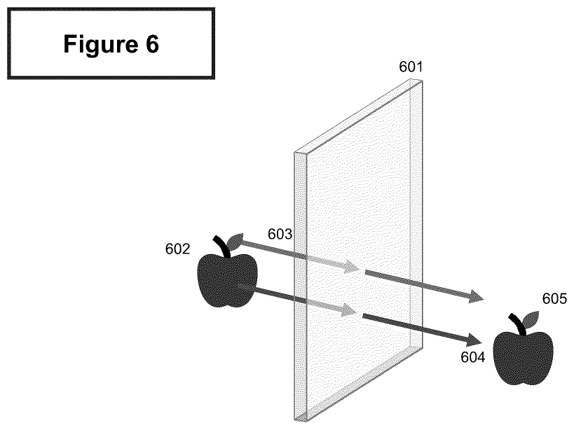

The effect of these filtering conditions is shown in FIGS. 5 and 6. In FIG. 5, the effect of the cyan and magenta filters are shown being applied to green and red apples. The magenta filter (501) is placed in front of the object (502), which is perceived to normally have green and red color (503). However, when perceived through the filter, the green wavelengths are filtered out (504), leading to a darker hue to previously green colors (505). This is similar to the cyan filter condition, where the cyan filter (506) is placed in front of the colored object (507) which is perceived and green and red (508). However, the properties of the cyan filter remove red wavelengths (509), meaning the red color of the object is seen as darker (510).

FIG. 6 shows the application of a full spectrum filter condition on the colored object, having the full spectrum filter (601) applied to the colored object (602) perceived as green and red (603). The application of the filter has no effect on the wavelengths (604), meaning the object is perceived with no differences (605).

What is claimed is:

1. A method for enhancing color contrast perception in individuals with color vision deficiency, comprising:
A. The application of multiple distinct optical filter conditions,
B. The extraocular implementation of these filter conditions to alter incoming light,
C. The dynamic modulation of filter conditions at high frequencies, either temporally, spatially, or both, to optimize contrast perception.

2. Each distinct filter condition in claim 1 is designed to selectively remove specific wavelength ranges of chromatic hues to enhance color differentiation for color vision-deficient observers.

3. The filter conditions as defined in claim 2 include “Magenta” (a filter which does not allow transmission of green range wavelengths) and “Cyan” (a filter which does not allow transmission of red range wavelengths).

4. The filter conditions as mentioned in claim 1 also include a “Full Spectrum” condition, which does not remove any wavelengths from incoming spectra.

5. A system for enhancing color contrast perception in color vision-deficient individuals, comprising:
A. A mechanism for presenting unique optical filter conditions that selectively remove specific wavelength ranges of chromatic hues,
B. A dynamic modulation system that alters filter conditions at predetermined frequencies.

6. The system in claim 5 is not limited to liquid crystal technology, but may include alternative methods, such as:
A. Manually or mechanically interchangeable optical filters,
B. Any other analog or digital optical filtering techniques that achieve dynamic wavelength modulation.

7. A device as specified in claim 5 which utilizes Liquid Crystal Matrices, whether in a Liquid Crystal Display or otherwise, to achieve active filtering needs.

8. A system as in claim 5 which can be programmed externally to determine specific filter transmission settings.

9. A system as in claim 5 to be used as a vision aid by human observers with color vision deficiency, including use as:
A. Glasses or optic filter eyewear designed for individual/personal use,
B. An integrated filtering system for windows, windshields, or other displays,
C. Hand-held optic assistive devices for smaller field of view perception.
